(19) United States
(12) Patent Application Publication
(10) Pub. No.: US 2005/0029174 A1
(43) Pub. Date: Feb. 10, 2005

(54) Hybrid magnetohydrodynamo (MHD) field sanitation generator for treating wastewater, sewages & sludge and recovering potable water

(76) Inventor: Carol Ann Collins, Philadelphia, PA (US)

Correspondence Address: Carol Collins, 152 Mike Ct, Elkton, MD, 21921, US

(21) Appl. No.: 10/636,532

(22) Filed: Aug. 8, 2003

(51) Int. Cl. B01D 17/06

(52) U.S. Cl. 210/143; 210/243; 210/748

(57) ABSTRACT

The Hybrid MHD-FSU (Field Sanitation Unit) innovation is a self-contained sewage treatment plant that fully converts sewage/wastewater into (1) solid organic material, (2) potable, pathogen-free drinking water, and (3) generates electricity. At a high level, the system consists of four main components: (1) Mixer, (2) MHD Reactor, (3) Filter, and (4) Turbine. The innovation presents a stand-alone compact configuration of typical wastewater treatment components (equalization & mixing, process treatment, filtration) that are combined with the customized MHD reactor to perform the waste treatment/water recovery processing.

The Hybrid magnetohydrodynamo (MHD) Field Sanitation Unit has the ability (1) to recover an organic material (2) to recover a pathogen free, clean potable drinking water, and (3) to generate electricity using wastewater as the conductive medium. The invention also relates a core heating microwave source coupled to an outer rigid mantle boundary that compose an MHD electrode pair. The invention assemblies are generally configured of three components: (a) magnetron, waveguide & a launch assembly; (b) the perovskite ceramic components; and (c) the conductive wastewater sludge fluid but more specifically the MHD assemblies are described herein in detail. FIG. 1 illustrates a general process flow of the invention. The main components of the invention are composed of the following: (1) the clean water supply feed, (2) the influent raw wastewater (3) the mixer, (4) the MHD reactor chamber, (5) the storage tank for clean water, (6) the filtration system producing potable water, (7) the storage bin for solids & organic material (8) hydro-turbine (9) the potable drinking water storage, (10b) the battery storage system with power conditioning subsystem.

### CROSS-REFERENCE TO RELATED APPLICATIONS

U.S. Pat. No. 6,419,837B1, Jul. 16, 2002, Inventor—James R. Akse, Raseberg, Oreg., USA

U.S. Pat. No. 6,159,422, Dec. 12, 2000, Inventor:—Clinton g. Graves, Clinton G. Graves II both of Danville,

U.S. Pat. No. 4,654,561, Oct. 7, 1985, Plasma Containment. Inventor—Jay D. Shelton, Fruita, Colo.

U.S. Pat. No. 3,160,566, December 1964, xxx. Inventor Handi et all. 376/130

U.S. Pat. No. 3,218,235, November 1965, xxx. Inventor—Ehler. 376/130

U.S. Pat. No. 5,968,400, Oct. 19, 1999, xxx Inventor—Wicks et al. North Aiken, S.C.

U.S. Pat. No. 6,344,638 B1, Feb. 5, 2002, Tomasello, Libertyville, Ill.

U.S. Pat. No. 5,925,324, Jul. 20, 1999, Greer, Little Rock, Ark.

U.S. Pat. No. 5,633,541, May 27, 1997, Hayes, Brossard, Canada

U.S. Pat. No. 6,362,449 B1, Mar. 26, 2002, Hadidi et al, Bedford, Mass.

U.S. Pat. No. 4,654,561, Mar. 31, 1987, Shelton, Fruita, Colo.

### STATEMENT REGARDING FEDERALLY SPONSORED RESEARCH OR DEVELOPMENT

Not Applicable

### REFERENCE TO SEQUENCE LISTINGS

Not Applicable

Specifications:

### BACKGROUND OF INVENTION

The embodiment of the invention presents a method for waste management using a renewable approach applying a hybrid Magnetohydrodynamo (MHD) Field Sanitation Unit (FSU). The background of the invention presents a method that combines & integrates the following technical fields: (1) magnetohydromagnetic (MHD) processes, (2) disinfection of infectious medical waste e.g. autoclave (3) microwave treatment of wastes & microorganisms (4) municipal wastewater treatment; and, (5) power generation via conversion of biomass directly to energy. The embodiment of the invention utilizes MHD processes with a method to recover potable water from wastewaters, sanitation sewage and sludge while inducing an electric field. Thus the Hybrid MHD FSU reactor chamber generates electricity using wastewaters & biomass directly as the conductive fluid. Prior art shows various applications, methods & apparatus generate power devised from ionized gases and/or waste gases acting as the conducting fluid. These gases are moved between two electrodes surrounded by a magnetic field generally produced using magnets or other such means as to produce a magnetic field. In addition, the embodiment of the innovation differs from the current process of bio-gasification, the conversion of biomass into a fuel. Thus, the objectives of the embodiment of the apparatus are (1) to recover an organic material (2) to recover a pathogen free, clean potable drinking water, and (3) to generate electricity using wastewater as the conductive medium. The FSU design relates a core heating microwave source to an outer rigid mantle boundary. The hybrid MHD assemblies are generally configured of three components: (1) magnetron, wave guide & a launch assembly; (2) the perovskite ceramic components; and (3) the conductive wastewater sludge fluid. The invention builds its special case upon the fundamental mathematics of fluid mechanics & revisits the MHD generator technologies that were disregarded in the 1960's. The invention recalls the freshness and simplicity demonstrated by the continuous electrode Faraday generator, the simplest form of MHDs

Magnetic fields influence many natural and man-made flows. MHDs, as a process or as a device, operate on many scales. For example, magnetic fields pervade interstellar space and aid in the formation of stars by removing excess angular momentum from collapsing interstellar clouds; or our sun's solar flares & sunspots. Our earth's own terrestrial magnetic fields are considered a geo-magnetohydrodynamo and is considered to be a slow dynamo action. The earth as a geo-MHD is maintained by the fluid motion in the core of the earth. MHDs are also man made. The earliest application of an MHD (1832) was found in the electromagnetic pump, which remains a simple device consisting of mutually perpendicular magnetic and electric fields arranged normal to the axis of a duct. The electromagnetic device is defined by a duct or passageway that is filled with a conducting liquid so that currents can flow, the resulting Lorentz force provides the necessary pump action. This electromagnetic pump is now being used in fast-breeder nuclear reactors where it is used to pump liquid sodium coolant through the reactor core The following are additional examples of MHDs: (1) In the metallurgical industries magnetic fields are routinely used to heat, pump, stir & levitate liquid metals. (2) In electrolysis, MHD is also important in reducing aluminum oxide to aluminum. (3) In industry, they are routinely used to heat, pump, stir and levitate liquid metals. (4) In engineering, the most widespread application of MHD is the use of electromagnetic stirring of molten metals. Here magnetic fields are used to dampen the motion of liquid metals during casting operations. The metallurgist takes advantage of the ability of a static magnetic field to convert kinetic energy into heat via Joule dissipation Another common application of MHD in metallurgy is magnetic levitation or confinement. This relies on the fact that at high-frequency induction coil repels conducting material by inducing opposing currents in any adjacent conductor (opposite currents repel each other). Thus, a basket formed from a high-frequency induction coil can be used to levitate and melt highly reactive metals, or a high frequency solenoid can be used to form a non-contact magnetic valve which modulates and guides a liquid metal jet. (5) MHD is also used to induce an electric field for power generation and propulsion. ²(REF: P. A. Davidson, An introduction to Magnetohydrodynamics, Cambridge University Press, 2001)

MHD as power generation is the conversion of kinetic or potential (pressure-volume) energy of a fluid into electrical power by interaction of the fluid with a magnetic field. For this interaction to occur, the fluid must be moving and it must also be an electrical conductor ³(REF: Womack, G. J., MHD Power generation Engineering Aspects, printed in Great Britain by Willmer Brothers, Ldt, 1969). In concept, MHD power generators are no different from conventional electric generators where the conductor is a solid metal, usually copper. However, in detail, MHD generators are very different because the conductor is a compressible conductive fluid. Formally, MHD is concerned with the mutual interaction of fluid flow and magnetic fields. The fluids in question must be electrically conducting which traditionally limited devices to using liquid metals, hot ionized gases (plasmas) and strong electrolytes. However, the embodiment of this invention teaches a method and a means by which wastewaters, sewage & sludge can be compressed and used as the conductive fluid. The embodiment of this invention models part of its design after the geo-magnetohydrodynamic processes found within the Earth's core and demonstrates a new way to generate electricity using wastewater while recovering a potable, pathogen free clean water resource.

Some of the obvious science of magnetohydrodynamics embodies the following discussion: The mutual interaction of a magnetic field, B, and a velocity field, u, arises partially as a result of the laws of Faraday and Ampere, and partially because of the Lorentz force experienced by a current-carrying body. The exact form of this interaction can be broken down into three parts:
a. The relative movement of a conducting fluid and a magnetic field causing an e.m.f. (electromotive force, of order (|u×B|) to develop in accordance with Faraday's law of induction. In general, the electrical currents will ensue, the current density being of the order σ(u×B), where a is denoted as the electrical conductivity.
b. These induced currents must, according to Ampere's Law, give rise to a second, induced magnetic field. This adds to the original magnetic field and the change is usually such that the field appears to “drag the magnetic field line along with it”
c. The combined magnetic field (imposed plus induced) interacts with the induced current density, J, to give rise to a Lorentz force (per unit volume), J×B. This acts on the conductor (the compressible fluid) and is generally directed so as to inhibit the relative movement of the magnetic field and the fluid.
d. When the conducting fluid enters the magnetic field, interaction will occur and an induced electric field is established normal to the flow and magnetic field directions and between electrode pairs and electrical potential can then be transformed into usable electrical power by various means.

This hybrid MHD FSU invention presents both a method to create a conductive fluid using wastewater, sewage, raw slurry & sludge; and, a method to utilize the thixotropic & psuedoplastic qualities of these fluids while generating power. In the past & presently still gaseous MHD researchers found it necessary to increase the electrical conductivity of the gases by “seeding them” with an easily ionizable substance, such as potassium or cesium. This innovation includes a method to increase the electrical conductivity of the wastewater in much the same way. However, the invention is comprised of various layers & geometries of conductive materials that, when in combination with the water & the metals found within the wastewater, sewage, raw slurry & sludge mixtures electrical conductivity is increased and sustained. The invention also embodies a means to provide a differential rotational flow resembling in a manner the presently perceived scientific notion that models the Earth's own planetary dynamo.

The technical field of this present invention also uses wastewater treatment methods that generally relate to current municipal wastewater treatment systems and also generally relate to treatment of biological & hazardous medical wastes containing pathogens & other infectious materials. Currently, the nature of wastewater is described by its flow and quality characteristics. Wastewater discharges are classified by whether they are from municipalities, industries, institutions, agricultural/rural or from other point sources. Generally municipal wastewater is composed of domestic (or sanitation) wastewater, industrial wastewater, infiltration and inflow into sewer lines, and storm water runoff. Domestic wastewater refers to wastewater discharged from residences and from commercial and institutional facilities. Agricultural waters are composed of runoff from any farming operation, livestock operation or other storm water runoffs composed of agricultural wastes. ⁴(REF: Metcalf & Eddy, Inc. 1991 Wastewater Engineering, 3^{rd} ed. New York: McGraw-Hill, Inc). Contaminants in municipal wastewater are introduced as a result of water usage for domestic, commercial or institutional purposes. Two main sources of water pollutants are point source & non-point source. Non-point pollutants are substances introduced into receiving waters as a result of urban area, industrial area or rural runoff; e.g. sediment and pesticides or nitrates entering surface waters due to wastewater discharge from agricultural farms. Point sources are specific discharges from municipalities or industrial complexes: e.g., organic or metals entering surface water due to wastewater discharge from a manufacturing plan. In a surface water body, non-point pollution can contribute significantly to total pollutant loading, particularly with regard to nutrients and pesticides. Municipal and industrial wastewater discharges are primary contributors to point source discharges. Wastewater quality can be defined physical, chemical, and biological characteristics. Pathogenic organisms in wastewater can be categorized as bacteria, viruses, protozoa and helminthes. Because of the many types of pathogenic organisms and the associated measurement difficulties, coliform organisms are frequently used as indicators of human pollution. On a daily basis, each person discharges from 100 to 400 billion coliform organisms, in addition to other kinds of bacteria. ⁵(REF: Metcalf & Eddy, Inc. 1991 Wastewater Engineering, 3^{rd} ed., New York: McGraw-Hill, Inc).

Pathogenic organisms in wastewater can transmit communicable diseases. General methods for physical microbial control are heat, filtration, radiation, refrigeration, and desiccation. Pathogen elimination include sterilization (steam), microwave treatments of hazardous & biological wastes (U.S. Pat. No. 6,159,422, Dec. 12, 2000).

Steam/heat disinfection is a standard process in hospitals for disinfecting reusable instruments and has recently been adapted for medical waste treatment. The two traditional types of equipment used for steam treatment are autoclaves and retorts. Other steam-based systems sometimes referred to as advanced autoclaves, have been developed in recent years. One unique design of a steam-based process is a microwave unit that achieves disinfection by means of moist heat & steam. An autoclave consists of a metal chamber sealed by a charging door and surrounded by a steam jacket. A retort is similar to an autoclave except that a retort has no steam jacket and are found in large scale applications. The types of waste commonly treated in autoclaves and retorts include cultures and stocks, sharps, materials contaminated with blood and limited amounts of fluids, isolation and surgery wastes, laboratory wastes (excluding chemical wastes), and soft wastes (gauze, bandages, drapes, gowns, bedding, etc) from patient care. Volatile and semi-volatile organic compounds, bulk chemotherapeutic wastes, mercury, other hazardous chemical wastes, and radiological wastes should not be treated in an autoclave or retort. Autoclaves and retorts require a minimum exposure time and temperature to achieve proper disinfection. Often the exposure times are based on twice the minimum time required to achieve a 6 log₁₀ kill of bacterial spores under ideal conditions; equivalent exposure times at different temperatures can be estimated. A common exposure temperature-time criterion is 121° C. (250° F.) for 30 minutes. Some current retort/autoclave innovations include the Bondtech (insulated retorts/autoclaves); Environmental Tectonics Corporation (ETC) who designs and engineers medical waste autoclaves; Sierra Industries (retorts & autoclaves); and SteriTech who treats medical red bags (infectious med waste). ⁶REF: Non-Incineration Medical Waste Treatment Technologies, E. Cole. “Chemical and Biological Exposures and Safety Hazards in Medical Waste Treatment Facilities: An Assessment of Alternative Technologies.” Vol. 98/2, No. 9 (Cedex, France: International Healthcare Waste Network (IhcWaN), Aug. 31, 1998). Additional biological waste treatment methods used to eliminate pathogens include pasteurization, employing the concept of equivalent treatments. As temperature increases less time is needed to kill a certain number of microbes that would take more time to kill at lower temperatures. Classical (bulk) pasteurization heated foods at 63° C. for 30 minutes. Today, flash pasteurization or high temperatures, short-time (HTST) methods are favored as they kill heat-resistant organisms more effectively and are less likely to alter the flavor of foods. The HTST methods involve continuous passage of foods past a heat exchanger. Dry heat sterilization, another method for microbial control, takes more time as it does not penetrate as well in the absence of steam. Filter sterilization is commonly employed for substances that cannot tolerate heat. Membrane filters with pore sizes between 0.2-0.45 μm are commonly used to remove particles from solutions that can't be autoclaved. Membrane filtration of beer eliminates spoilage germs and pasteurization is no longer needed. Submicron milters are also being marketed for removal of protozoan cysts from drinking water. Radiation involves the use of radiation to control microbes. The effects of types of radiation depend upon the time of exposure, the distance from the source and shielding (penetration of the radiation frequencies). Non-ionizing radiation includes microwaves and ultraviolet radiation. UV radiation is of short wavelength, between 220 and 300 nm and is not very penetrating. UV can be stopped by glass, a sheet of paper, or the top layers of skin. UV rays can kill exposed microbes by causing damage to their DNA. Ultraviolet radiation frequencies are useful for the disinfection of exposed surfaces however; the usefulness of UV radiation is limited by the fact that certain microbe's posses DNA repair mechanisms and can recover after exposure to this kind of radiation. In addition, UV light does not penetrate organisms well that are protected in mucous or debris. Ionizing radiation includes gamma rays and X-rays which are highly penetrating to cells and tissues and have potent anti-microbial effects. After colliding with a target, ionizing radiation generates ions and other reactive species from molecules including hydroxyl (free) OH-radicals. These free radicals can cause irreversible breaks in DNA, proteins & enzymes. Radiation is currently used for sterilization by the medical supply and food industries. The US Food & Drug Administration has approved irradiation for sterilization of surgical supplies, vaccines and drugs. Irradiation of spices and seasonings has grown over the use of ethylene oxide gas. This gas must be expelled from products before use, and is mutagenic (possible cancer causing agent).

Microwave systems disinfection is essentially a steam-based process, since disinfection occurs through the action of moist heat and steam generated by microwave energy. Microwaves are very short waves in the electromagnetic spectrum used to convert high voltage electrical energy into microwave energy. This energy is then transmitted into a metal wave-guide that directs the energy into a specific area (such as the cooking area of a microwave oven or the treatment section of a disinfection unit). What makes microwave technology an effective quick cooking device also makes it useful as a disinfection system. The waves of microwave energy cycle rapidly between positive and negative at very high frequency, around 2.45 billion times per second. This causes water and other molecules in the waste (or in food) to vibrate swiftly as they try to align themselves (like microscopic magnets) to the rapidly shifting electromagnetic field. The intense vibration creates friction, which, in turn, generates heat, turning water into steam. The heat denatures proteins within microbial cells, thereby inactivating pathogens. Studies have shown that without water, the lethal effects of microwaves on dry microbial samples are significantly reduced. Studies have also concluded that microbial inactivation was not due to the microwave field as such but because of heat. Thus, microwave treatment systems generally add water or steam into the waste input stream as part of the treatment process (Clinton, et al. U.S. Pat. No. 6,159,422, December, 2000). Microwave units routinely treat sharps waste such as needles and wastes containing pieces of metal. It is a misconception that metals cannot be treated in the microwave disinfection system. Metals that are too large or too hard to go through the shredder, such as steel plates or prosthetic pieces, cannot be treated in the unit because they would damage the shredder. In general, microwave disinfection systems consist of a disinfection area or chamber into which microwave energy is directed from a microwave generator (magnetron). Typically, 2-6 magnetrons are used with an output of about 1.2 kW each. Some systems are designed as batch processes and others are semi-continuous. The microwave treatment system that has established itself in the alternative technology market is manufactured by Sanitec International Holdings. It consists of an automatic charging system, hopper, shredder, conveyor screw, steam generator, microwave generators, discharge screw, secondary shredder (“particlizer”), and controls. The equipment includes hydraulics, high-efficiency particulate air (HEPA) filter, and microprocessor-based controls protected in all-weather steel enclosures. The operation of a microwave unit is as follows, based on a Sanitec Microwave system: (1) waste loading (red bags loaded into carts that attach to the feed assembly, high temperature steam is then injected into the feed hopper, while air is extracted through the HEPA filter, the top flap of the gopper is opened and the medical waste is inserted into the hopper; (2) internal shredding first breaks down the wastes by a rotating feed arm and the waste is ground into smaller pieces by shredding; (3) microwave treatment: the shredded pieces are conveyed through a rotating conveyor screw where they are exposed to steam then heated to 95° C. and 100° C. by four or six microwave generators for a minimum of 30 minutes (4) the treated waste may be passed through a second shredders

Current methods of wastewater treatment include (1) Equalization Primary Treatment (equalization basins, screens & comminutors (mixers, shredders, etc.) grit removal, grease removal & sedimentation, flotation & foaming & sludge pumping & transportation, septic tanks; (2) Secondary Treatment: activated sludge, trickling filters, aerobic/extended aeration. ponds & lagoons, anaerobic digestion, secondary clarification & disinfection; and (3) Advanced Tertiary Treatment: Filtration Enhanced by Applied Chemical Coagulants, Ultra-filtration Membranes, coagulation systems & Chemical Neutralization & electrolysis, etc.

U.S. Pat. No. 6,344,638 B1 to Tomasello teaches “a continuous method of processing medical waste which includes the steps of continuously feeding medical waste into a tube and heating the medical waste passing through the tube with electromagnetic radiation so as to heat and disinfect medical waste”. The hybrid MHD FSU differs from this patented apparatus/method. Tomasello's process does not specifically approach the elimination of pathogens nor does it treat wastewaters, infectious waters and sewages to recover potable water nor does this treatment process generate electrical power in the process of treatment.

U.S. Pat. No. 5,958,400 to Wicks, teaches an invention that discloses a tandem microwave system consisting “of a primary chamber in which microwave energy is used for the controlled combustion of materials; where a second chamber is used to further treat the off-gases from the primary chamber by passage through a “susceptor matrix” subjected to additional microwave energy”, In this patent the direct microwave radiation and elevated temperatures provide for significant reductions in the “qualitative and quantitative emissions of the treated off gases that are utilized for disinfecting wastes, sterilizing materials, and or modifying the form of wastes to solidify organic or inorganic materials.” Herein, this prior art has as its primary concern the disinfection of medical waste where in the primary chamber microwave energy is used for the controlled combustion of materials while in a second chamber microwave energy is used to further treat the off-gases from the primary chamber. This tandem microwave system disinfects wastes and does not treat wastewaters nor sewage nor recover potable water and therefore differs from the hybrid MHD FSU.

U.S. Pat. No. 5,633,541 to Hayes teaches the use of a MHD electric generator which is devised that the coherent light generated in it by electrical stimulation, heat induction and/or gas expansion is collected and focused towards the gas plasma moving between the magnets and electricity-collecting plates. In this generator, the composition of the laser gas mixture is also controlled and adjusted to compensate for the unavoidable loss occurring in operation, when some of the gas molecules, especially CO₂ are dissociated. The prior art utilizes special gases to create the gas plasma moving between the magnets and electricity collection plate. The prior art is very similar to the early MHD generation devices that operated during the 1960's through 1970's and are still very actively used in Japan and elsewhere. However, the proposed hybrid MHD FSU apparatus utilizes wastewaters, sewages & sludge which greatly diverges from the prior art that generates power using waste combustion gases and/or ionized gaseous plasmas. The proposed innovation finds its model in the slow geo-dynamic differential rotation of the Earth rather than the prior art of MHD power generation. Also, as will be described within in the detailed description of the invention the electrodes within the proposed embodiment are structurally & functionally different than the traditional electrodes of this apparatus. This prior art also does not recover a clean potable water resource.

U.S. Pat. No. 5,958,400 to Greer teaches the use of MHD sterilization system in a method involving the use of MHD for the specific purpose of destroying populations of microorganisms occurring in, within or on fluid, semi-fluid, semi-solid or solid materials. This patent uses the microwave properties of a “magnetohydrodynamic cell comprising a passageway for said material being sterilized to pass and a means for establishing an adequate magnetic field that is substantially perpendicular to said passageway, and a means for concurrently generating an adequate electrical field substantially normal to said magnetic field and said passageway wherein said means for establishing the magnetic field comprises a means to substantially enclose the cell”. MHDs include natural processes and can be found in planets like our Earth, in stars like our Sun & in nebula forming new stars like that found in the constellation, Orion. An MHD also includes man made devices that include methods for propulsion, power generation, controlled thermonuclear fusion to pump liquid metal, to heat, stir & levitate liquid metal and as an electromagnetic pump or turbine. MHD is concerned with the mutual interaction of fluid flows and magnetic fields. Thus, while pathogens & microorganisms are eliminated within the proposed apparatus, the prior art substantially, significantly and completely differs from the proposed apparatus within the embodiment of the proposed innovation in that an MHD is the most efficient method to recover potable water and generate electricity using wastewater, sewages & sludge as the compressible conductive fluid. The differences are striking. The prior art uses a small MHD cell and a passageway that is confined by an imposed magnetic field while an adequate electrical field is being generated by a power supply means to increase conductivity. In the proposed embodiment, the MHD is created from an entirely different geometry than the prior art. In the proposed innovation an electromagnetic radiation microwave/radio frequency device, and in the special case, a magnetron, is embedded within a cubic perovskite ceramic representing a core internally located within the MHD reactor chamber. This comprises one hybrid & uniquely constructed “electrode”. The influent wastewaters, sewage & sludge are directed into the chamber and distribute a vortical velocity flow around the core radiation field. This compressible fluid is the conductive medium. The boundary mantle of the MHD reactor is spherically bounded by a rigid fabricated perovskite ceramic aggregation of proppants, or spackles woven layers of same fabricated ceramics with embedded pillared clays and this rigid wall boundary mantle comprises the second electrode of the MHD. Externally, magnets are placed upon the outer shell of the spherical mantle boundary to confine the fluid within a plasma field. The mutual attraction of a magnetic field, B and a velocity field, u, arises partially, as a result of the heating of the core magnetron assembly. Magnetic fields behave differently depending upon the conductivity of the medium. The current carrying body is the wastewater, sewage sludge, compressible fluid. The proposed embodiment eliminates infectious pathogenic microorganisms by its very nature, and, the design of the hybrid MHD-FSU is to recover potable pathogen free water while inducing a strong enough electric field to generate power. The proposed embodiment is therefore an MHD generator using wastewater, sewage, raw slurry & sludge to generate power while recovering potable water.

U.S. Pat. No. 6,362,449 B1 to Hadidi teaches that “a very high power microwave plasma torch includes a source of microwave energy which is propagated by a fundamental mode waveguide or a quasi-optical overmoded waveguide. The waveguide has no structural restrictions between the source of microwave energy and the plasma to effect resonance. The gas flows across the waveguide and microwave energy is coupled into the gas to create a plasma. The plasma torch is used within a furnace for heating material. While the prior art uses a waveguide and very high powered microwave plasma torch this art differs from the proposed invention. An embodiment of the proposed invention uses a waveguide to distribute electromagnetic energy, however, the microwave/radio frequencies generated are diffused outwardly from within a core located internally within the fluid material being treated. The electromagnetic radiation thermally diffuses into the wastewater slurry fluid and assists in sustaining the advection and diffusion of heat through this raw slurried fluid. Thermal diffusivity distributes within the sludge reactor chamber in much the same manner as the vorticity evolves.

U.S. Pat. No. 4,654,561 to Shelton teaches that a plasma containment device for generating and sustaining a ball of plasma includes an enclosure; a primary electromagnet for generating a primary magnetic field in said enclosure; gas jets positioned at terminal end portions of the primary magnet pole pieces for providing gas under pressure to said enclosure generate a plasma ball in said enclosure and maintain a large circular electric current within the plasma ball. The prior art was adapted to simulate, in a controlled environment, some of the environmental conditions present during the propagation of natural ball lightning in order to provide a plasma ball capable of being sustained indefinitely. This prior art relates an ability to confine a gaseous plasma within a spherical containment field and uses a large electromagnet for that purpose. The apparatus proposed although spherical is not composed of metals but rather fabricated ceramics composed of various formulations of perovskite materials and other clay composites. The purpose of the proposed MHD-FSU invention differs from that of the prior art.

### BRIEF SUMMARY OF THE INVENTION

The embodiment of the hybrid MHD-FSU (Field Sanitation Unit) innovation is presented as a self-contained sewage treatment plant that fully converts sewage/wastewater into (1) solid organic material, (2) potable, pathogen-free drinking water, and (3) generates electricity. At a high level, the system consists of four main components: (1) Mixer, (2) MHD Reactor, (3) Filter, and (4) Turbine. The innovation presents a stand-alone compact configuration of typical wastewater treatment components (equalization & mixing, process treatment, filtration) that are combined with the customized MHD reactor to perform the waste treatment/water recovery processing. Generally speaking the FSU process is as follows: The waste sludge is piped into a holding/equalization tank temporarily awaiting the FSU process to start:
Step 1. The waste stream is piped thru computer assisted monitoring sensors & analyzes the waste materials and adjusts the slurry by adding water And to mix it to make it more homogenous prior to MHD delivery. The mixer includes a means to shred and deliver the raw slurry beneficially utilizes the thixotropic and psuedoplastic properties of wastewater to provide a means of developing a consistent compressible fluid mixture. This entire batch processing is expected to take from 15 to 30 minutes and a semi-continuous method is also suggested in the embodiment of this innovation.
Step 2: The hybrid MHD receives the slurry into the perovskite ceramic lined walls. The core heating source is represented by the magnetron assembly embedded within a second perovskite formulated ceramic waveguide cubic geometry specifically designed to couple to the outer perovskite mantle boundary sludge reactor walls. These wall materials are fabricated from various conductive ceramic materials into aggregates of proppants, spackles & even woven into fabrics to serve as one “electrode-like” assembly. This electrode assembly represents only the function of an electrode but is not modeled in geometry nor fabricated in the size of a typical electrode. This electrode represents one claim of this innovation. Once the slurry is placed within the MHD reactor the decomposition process is initiated. Herein, various mechanical & electrical means are used to generate the initial magnetic field, as well as, to induce a second magnetic field, the acoustic wave disturbances and the ion injections within the MHD reaction chamber. Herein, the MHD can be considered an electromagnetic turbine. The MHD reactor chamber is sealed shut, the differential rotational motion is generated via external motor sources outside the reactor but individually connected each to one of the two polar connections (north & south). Thus, a velocity field is generated an angular momentum creates a strong vorticity and the secondary magnetic field is generated. The generation of an acoustic wave is initiated via a piston method or even via a piezo-electronic motor method or any other such method as is deemed practical to the overall generation of standing waves within the chamber at a programmable spherical harmonic relationship to the compressible fluid. During scheduled pulsations ions are additionally injected into the system reactor as seed ions to further increase the induction of the electric fields. The microwave energy is isotropically distributed out from the core perovskite-magnetron assembly. All of these factors contribute to the elimination of the pathogens. The generation of power is a complex series of events that occur within the slow dynamo process that the Hybrid MHD FSU reactor chamber was designed to create. In addition, the embodiment of this invention includes components to regulate the temperature, light wave & microwave frequencies, velocity fields, momentum, etc. During the batch or semi-continuous processing various materials are resource recovered via the filtration system. For example, the 20% bio-solids, (human fecal matter composition) can be used for high-grade fertilizer or filler for various construction materials. The various metals found in the waste can additionally be filtered or adsorbed via ion-exchange filtration methods for collection &/or re-use. The recovered water can have the finer solid particles precipitated out and added to the solid organic material. During this process an electrical field is generated and electrical power can be further transformed and stored into battery packages.
Step 3: The “pathogen free” waster is piped into an off-the shelf RO filtration system or any other means of Reverse osmosis for removing any missed contaminants & organics. The water is then available for potable use. Before storing the water it can be optionally fed through a micro-turbine to generate additional potential energy to the battery storage.
Step 4. The additional hydro-turbine is used to generate energy for battery storage. The processed water can be stored for potable onsite-re-use.

The innovation treats water from both point sources & non-point sources. The innovation includes, primary, secondary & tertiary means to treat the wastewater and recover potable water. The Hybrid MHD-FSU generator differs from the prior art in that this innovation combines a method to destroy pathogens and a means of modifying various field strengths, modalities, harmonics, frequencies generated. The invention also relates to prior art a means of filtration, crushing, mixing, shredding or waste waters of varying compositions and sewage to present the influent in a homogenous raw slurry prior to treatment within the Hybrid MHD-FSU sludge reaction chamber. The invention's purpose is to treat sewage & wastewater produced more specifically from rural, agricultural, livestock operations & municipal wastewater human activities, eliminate the pathogen content in the form of viruses, bacteria, protozoan & hilmenths recovering a potable water resource while inducing an electric field that can be transformed into electrical power. The innovation is a stand alone system that can be scaled up or down. The innovation can be portable, packaged, stationary &/or retofitted within an existing municipal treatment plant either in combination with or as an emergency back up system.

Thus, this invention diverges significantly from the prior art and current methods of municipal wastewater treatment. The innovation eliminates the pathogens through the combined use of (1) multiple harmonic modalities of targeted electromagnetic radiation (microwave & radio wave frequencies; and, (2) the generation of an acoustic wave disturbances within the compressible waste water fluid as diffused through the sludge reactor.

### BRIEF DESCRIPTION OF SEVERAL VIEWS OF THE DRAWING

FIG. 1 shows a process flow diagram that illustrates the 10 major components of the total MHD Field Sanitation Unit for processing sewage wastewater and sludge materials.

FIG. 2 shows a plan view schematic of the essential components of the MHD-FSU treatment system at a higher level showing the major components

FIG. 3 shows a plan view of the magnetron assembly

FIG. 4 illustrates a more detailed schematic of the MHD-FSU reactor chamber calling out the cubic core, magnetron assembly and three spherical mantle boundary layers.

FIG. 5 shows a plan view diagram of an embodiment of the cubic ceramic for encasement of the magnetron that functions primarily as a waveguide assembly.

FIG. 6 shows a schematic of the MHD-FSU reaction chamber coupled to the electrical apparatus which includes the magnetron assembly with the differentially rotated motor mounts located at the north (15) and south (16) polar locations on the reactor chamber.

FIG. 7 shows a plan view of an embodiment representing the layers of perovskite ceramic materials with pillared clays embedded in the outer mantle boundary surrounding the cubic core.

FIG. 8 Battery system including the Power Conditioning Sub-system (off the shelf packaged system from OEM)

### DETAILED DESCRIPTION OF THE INVENTION

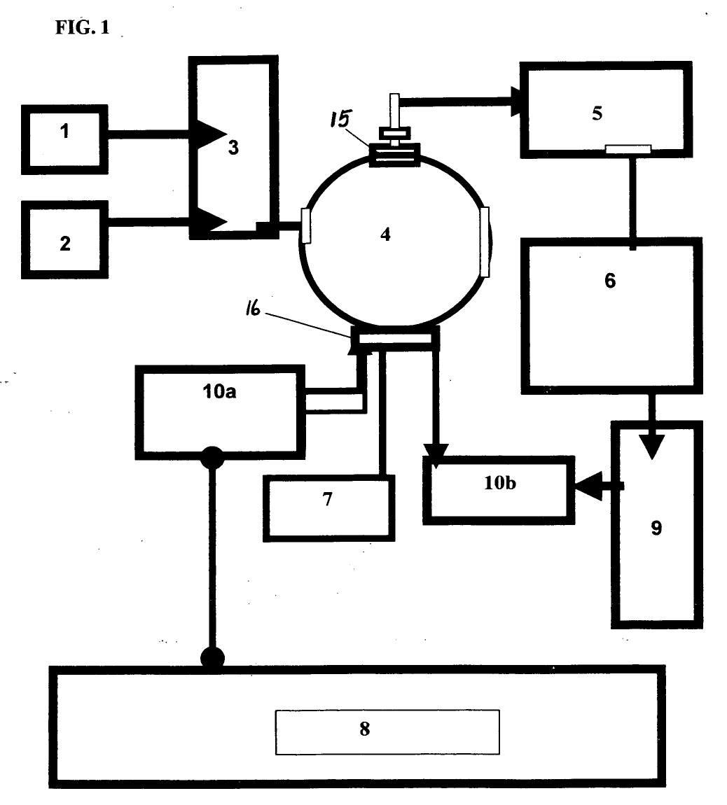

Herein, is presented the hybrid magnetohydrodynamo (MHD) Field Sanitation Unit (FSU). Thus, the objectives embodied within the apparatus are (1) to recover an organic material (2) to recover a pathogen free, clean potable drinking water, and (3) to generate electricity using wastewater as the conductive medium. The invention also relates a core heating microwave source coupled to an outer rigid mantle boundary that compose an MHD electrode pair. The invention assemblies are generally configured of three components: (a) magnetron, waveguide & a launch assembly; (b) the perovskite ceramic components; and (c) the conductive wastewater sludge fluid but more specifically the MHD assemblies are described herein in detail. FIG. 1 illustrates a general process flow of the invention. This process flow diagram presents the main components of the invention, which are composed of the following: (1) the clean water supply feed, (2) the influent raw wastewater (3) the mixer, (4) the MHD reactor chamber, (5) the storage tank for clean water, (6) the filtration system producing potable water, (7) the storage bin for solids & organic material (8) hydro-turbine (9) the potable drinking water storage, (10b) the battery storage system with power conditioning subsystem.

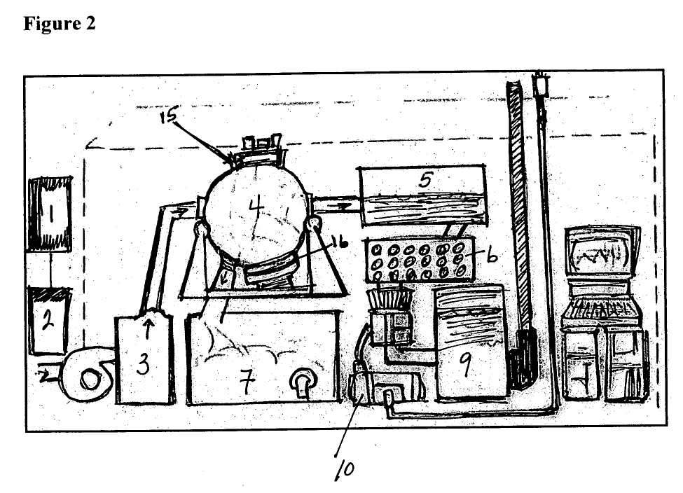

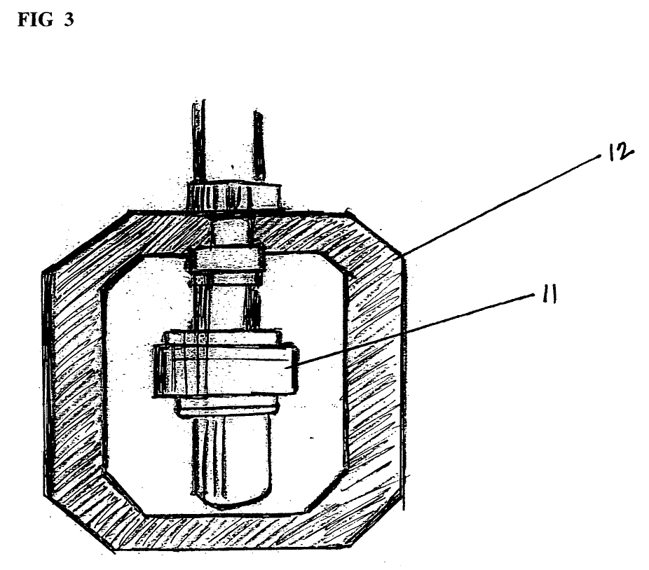

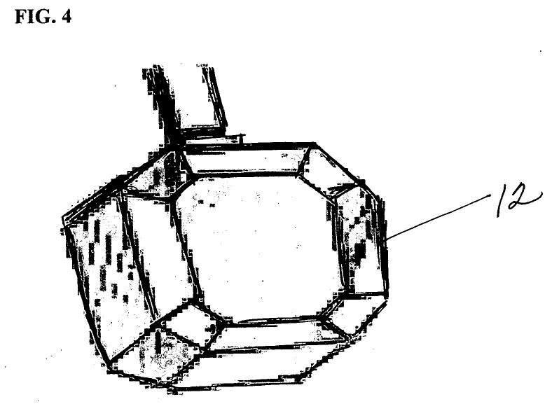

FIGS. 1 and 2 show the influent raw wastewater (2) inlet feed is pumped using piston pumping equipment (pump is not seen in the figure) into the mixer (3). Additional clean water (1) is added into the mixer (3) if required. The mixer (3) includes a means to blend, shred & mix the raw sewage, wastewater, sludge influent feed, into a uniform incompressible heterogeneous fluid. The mixer then passes the raw slurry into the MHD reactor chamber (4) and the doors are sealed tightly shut. FIG. 3 shows two mounted motors located on the north and south polar locations of the spherical sludge reactor (15 & 16) begin to initiate a slow dynamic differential rotation whereby the north mounted motor (15), which is connected to the magnetron (11)-cubic core (12) assembly (FIG. 3 item 12 & 4), is rotated oppositely by the south mounted motor (16) which is connected to the first outer rigid perovskite spherical boundary mantle (13). The second outer rigid mantle boundary (14) surrounds the first outer mantle boundary (13).The third spherical chamber (19) designed to shield the MHD FSU reactor and encases the first and second chambers. The entire MHD reactor is located within a three dimensional square structure (18). There can be inserted optional impellers to increase the rotational velocity (28a, b) The microwave/radio wave high frequencies are generated by a magnetron (11) and are powered by a standard DC battery (FIG. 1-Item 10) supply package or a wall installed AC power source (10a). The reactor chamber is sealed during the processing of the treated waste. After treatment the organic solids are discharged into a holding tank (FIG. 1-Item 7) located under the sludge reactor chamber (FIG. 1-Item 4) for analysis. FIG. 1 shows the clean water is sent into a receiving tank (5) prior to being discharged into the filtration system (6). The filtration system, for this current invention model, are composed of off the shelf packaged spiral wound filters purchased from several existing water treatment OEM manufacturers. The discharged treated potable water is then gravity fed through these packaged filters for further treatment using spiral wound filter assembly (6) and the water passes through each filter in a specified series which is not shown in the diagram. The filtration system is specifically designed to produce potable drinking quality water. After filtration the potable clean drinking water is discharged into a water holding tank (9) and then is passed through a hydro-turbine system (9) and the recovered electrical energy is transformed and sent into battery storage assembly (10b). The Battery Storage system includes a Power Conditioning Subsystem (PCS), (20-25, FIG. 8) which is composed of an interface (20) between the MHD and the battery storage system (FIG. 8), an inverter (23), which is a set of electronic switches that change DC voltage from battery to AC voltage for AC loads, a transformer (24) which are purchased off the shelf. The invention can be configured as a portable packaged unit and powered by a battery, generator set or alternative power source. The invention can also be connected to a barn, home, small municipal power station or military tent city power station or any other such application that requires wastewater treatment and/or water reclamation and/or power generation from wastewaters, sewage or sludge. The invention will be connected to a computer system in the future to analyze the wastewater contents prior to processing. The future computer integration will also include a means to integrate programmable software to operate the system from a remote location. Presently, the invention must operate using standard mechanical means to power pumps, discharge waste streams and transport water using typical fluid mechanical systems (e.g. pumps, pumping stations, power supplies and the like).

The magnetron component includes the (1) Microwave Discharge Component (magnetron), and (2) the waveguide and launch assembly which is embodied within the cubic ceramic wave guide apparatus. The magnetron assembly is composed of a 1000-Watt magnetron or a 100 kW high powered L-Band industrial magnetron which requires 130 kW power input and operates at 380 V, 915 MHz (frequency) with 75 kW power constant. The selection of the magnetron is determined by raw sewage volumes, load & retention time. For the 100 kW L-Band industrial magnetron an interlock is required to prevent the use of too low a magnetic field. The minimum safe electromagnetic current which can be used with a 400Ω internal impedance is 3.0 A. Below this, π-1 moding is likely to occur, causing damage to the magnetron. If the magnetron is to be operated from a 3-phase bridge rectified supply, then a smoothing choke of 3.0 H minimum is essential. The internal impedance of the HT should be such as to limit the peak anode current to 24A in the event of magnetron arcing. The use of a reverse power detector is recommended to cut off the HT supply if the power reflected into the magnetron exceeds the minimum power.

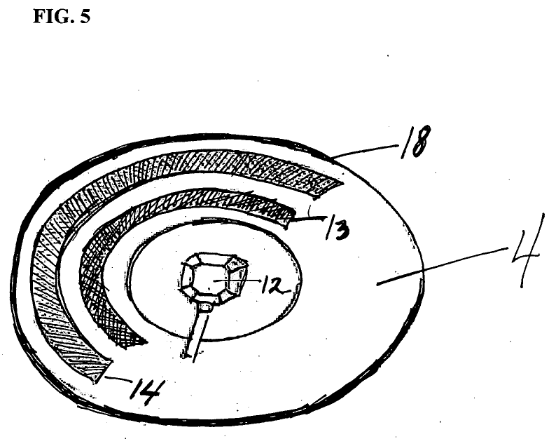

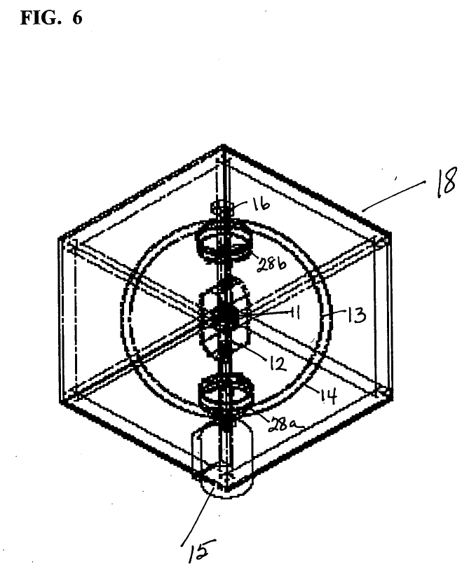

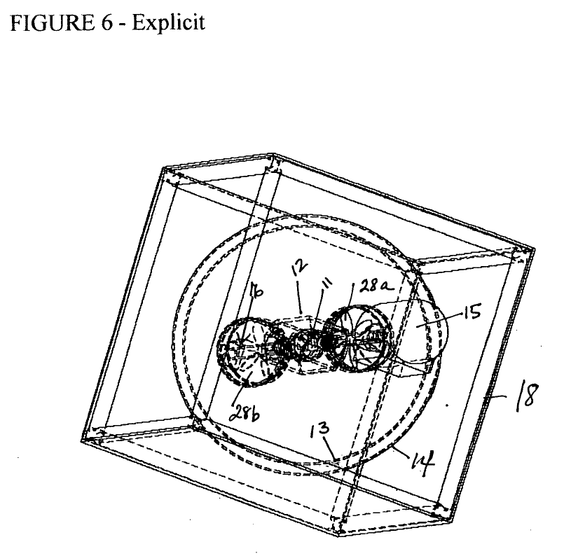

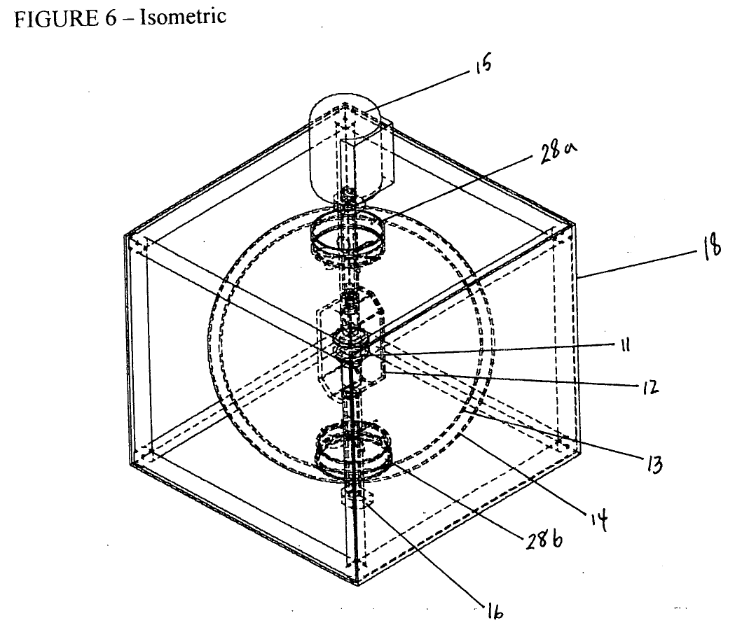

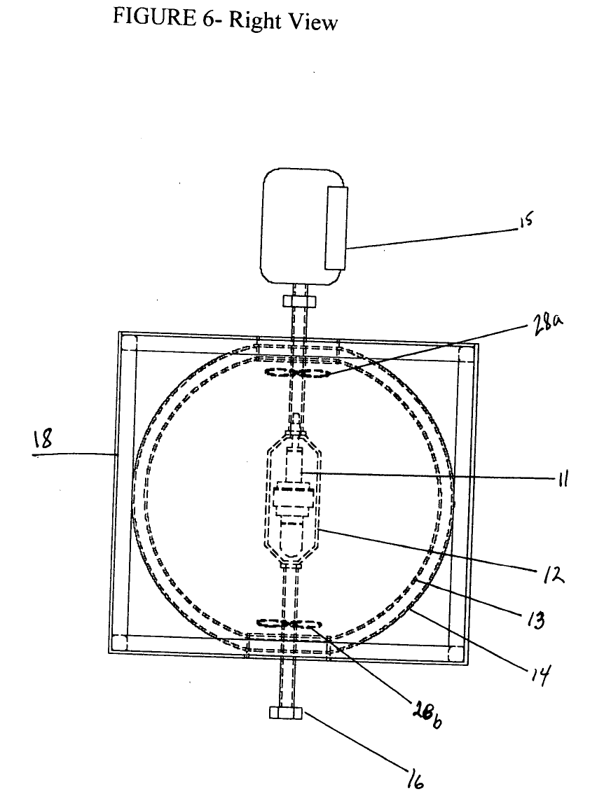

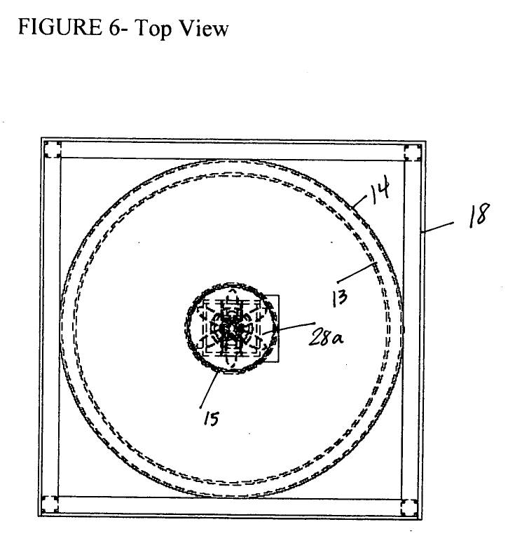

FIG. 3 and FIG. 6 illustrate the magnetron and core assembly components generally. FIG. 4 and FIG. 5 specifically illustrate different views of the cubic ceramic waveguide that encases the magnetron assembly. The fabricated perovskite ceramic with its cubic geometry was specially designed for this invention. It differs significantly from the typical rectangular channel normally made of sheet metal with reflective walls that allow the transmission of microwaves from the microwave cavity (applicator). The change in geometry is necessary to this invention. As, there has rarely been a perfect match between the microwave frequency used and the resonant frequency of the load it was necessary to restructure the waveguide in this innovation to relate specifically with the outer rigid boundary perovskite ceramic layer as an electrode pair which is one of the claims presented. The invention also presents the preferred cubic geometry of the core rather than a spherical core. A cubic geometry of the core assembly relates the isotropic properties spherically (with an infinite number of infinite axes and an infinite number of planes (to more uniformly diffuse the electromagnetic energy fields into the conductor (the fluid raw slurry). The invention uses a core-mantle design wherein the core magnetron dielectrically heats the fluid internally while the magnetic field additionally diffuses throughout the conductor (fluid slurry) in precisely the same way as the heat or vorticity (localized regions of intense rotation). These forces are common in many heated fluid flows. The combined magnetron ceramic perovskite cubic core assembly is inserted within a second outer spherical perovskite vessel and attached to both the top and bottom polar coupling mounts. The invention utilizes a magnetron as the core where prior art does not. The invention does so because the magnetron exhibits both dielectric heating properties and its dipolar polarization whereas, water, as found within the wastewater, sewage and sludge also exhibits dipolar dielectric properties. It is because the magnetron is a thermionic diode having an anode and a directly heated cathode that we designed a cubic ceramic waveguide that differs significantly from the prior art. And, within the magnetron as the cathode is heated, electrons are released and are attracted toward the anode. The anode is made up of a number of small cavities, each of which acts as a tuned circuit. The gas across the ends of each cavity behaves as a capacitance. The anode is therefore a series of circuits that are tuned to oscillate at a specific frequency or its harmonic overtones. This is the property that the invention couples to the cubic ceramic materials' dielectric properties. As a very strong magnetic field is induced axially, through the anode assembly, it has the effect of bending the path of the electrons as they travel from the cathode to the anode. As the deflected electrons pass through the cavity gaps they induce a small charge into the tuned cavity. The cubic ceramic was designed to replace the traditional rectangular sheet metal waveguide because of the design of the magnetron cavity and because of its functions. Thus it has been important to review here in the description of this invention.

It has also been important to note that this invention uses wastewater as the conductive fluid rather than the traditional waste gas or ionized specialty. The significance relates here that the invention couples the dielectric properties of water and builds upon the dipolar relationship between the properties of water and the dipolar polarizing properties of the magnetron in order to effectively sustain an electrically conductive fluid out of the water. It is noted also here that in microwave decomposition methods, the microwave range of frequency of the industrial oven is the time in which change is about the same as the response time of the dipoles. They rotate because of the torques they experience but the resulting polarization lags behind changes of the electric field. When the microwave field is at maximum strength, say in the upward direction, polarization may still be low. It keeps rising as the field weakens. The lag indicates that when using water, water absorbs energy from the field and is heated. Dipolar polarization, such as that excited in liquid water, is due to its dipole moment which in turn results from the differing electronegativity of the oxygen and hydrogen atoms. At low frequency the time taken by the electric field to change directions is longer than the response time of the dipoles, and the dielectric polarization keeps in phase with the electric field. The field provides the energy necessary to make the molecules rotate into alignment. Some of the energy is transferred to the random motion each time a dipole is knocked out of alignment and then realigns. Now, presented here is also presented that the dielectric properties and dielectric loss of the ceramic materials have been matched to the dielectric properties of water as well as them major properties of wastewaters, sewage and sludge. The efficiency of matching the cubic ceramic waveguide material to the conductive fluid (water) is measured by the standing wave ratio

Since dielectric properties of the material depend upon the temperature, the matching requirements of the cavity within the core-magnetron assembly are continually changing and are controlled by computer integration. Use of a resonant cavity increases the effective cavity power by 3 orders of magnitude allowing the microwave heating of relatively low-loss materials such as polymers and some ceramics using smaller powers (<2.5 kW). The invention integrates these components uniquely based upon the harmonic qualities of the materials and the electromagnetic radiation frequencies.

The invention further describes here that the wastewater raw slurry once fed into the MHD sludge reactor flows around the internally placed core. This wastewater raw slurry is acting as the liquid outer core to the inner cubic core and with the integration of the fields to materials to frequencies becomes a conductive fluid. It is further described that it is because of the fluid magnetohydrodynamics of the system design that the raw slurry is subject to electrical & magnetic forces, velocity, vorticity, convection, advection, thermal diffusivity, boundary conditions, shear stresses and acoustic pressure disturbances. And, once the wastewater raw slurry enters the MHD reactor chamber a cohesive integration of the components create a whole integrated system that becomes more dynamic than the individual parts. Herein, it is further important to note that the rigid mantle boundary is specifically spherical and relates to the magnetron in a core-mantle boundary relationship. And, both core & mantle are composed of semi-conductive materials with embedded magnets strategically placed within the outer mantle boundary layers by design. By comparison, traditionally the walls of the typical sheet metal waveguide normally reflect the electromagnetic energy and absorbance is increased because the energy passes through the sample more often and can be partially absorbed by each passage. However, the cubic ceramic embodied within this invention is a composite of MgFeNi-ceramic perovskite materials and it the Hybrid MHD reactor ceramics are designed to couple with the electromagnetic field energy and focus the electric field path produced by the standing waves set up in the cavity of the magnetron. In addition, the resonance mode is tuned to the characteristics (resonant working frequency) of the conductive raw slurry fluid. The particular resonant mode or electric field distribution pattern is selected and is distributed outward isotropically. There is also an acoustic pressure wave associated with this geometry. The imposed acoustic standing waves are generated by embedded piezoelectric material that is designed to increase viscosity, turbulence, and shear stresses. The purpose is to maintain the velocity fields and induce a freezing of the magnetic field internally to the fluid. There can also be found within this invention acoustic amplification crystal ceramic proppants embedded within the perovskite layers whose function is to distribute acoustic pressure pulsations into the raw slurry thereby influencing the velocity fields and thus, the viscosity of the fluid.

It is further described herein this invention presents a cubic perovskite MHD encasement (12) & the first outer spherical rigid mantle boundary (13) that covers the liquid fluid conductive core as composing the MHD reaction chamber where the wastewater is initially treated and the induced electric field is generated from the process. This first outer perovskite rigid mantle boundary couples to the cubic ceramic and relates to a pair of electrodes of which the conductive fluid flows between in a manner normal to magnetohydrodynamics. Additionally, the boundary surfaces are anticipated to develop streamlines and cell formations with the internal heating of the inhomogeneous conducting fluids. Now it has been presented the MHD encasement the cubic core ceramic is centrally located within the spherical MHD sludge reactor and that it is semi-conductive. This first outer ceramic represents the liquid core rigid mantle boundary and is related directly to the internal cubic-magnetron assembly core apparatus (12). The mantle does not act as an insulator. Rather, the mantle boundary is semi-conducting and currents can exist within the mantle and a toroidal field can exist here as well. The presence of toroidal fields in the semi-conducting mantel can be imagined as originating from outward diffusion of a toriodal field produced from the core. To gain more insight into the toroidal magnetic field we consider the special case of a velocity field generated from the core apparatus distributed isentropically and creating localized regions of intense rotation (vorticity) to arise. The velocity shear given by v=(0,Rω,0), leads to a toroidal magnetic field H=(H_{R},H₇₄,H_{Z}) generated by the dielectric heating of the magnetron core assembly act upon the toroidal magnetic field. Symmetry dictates that this magnetic field can be represented in spherical coordinates, (r,θ,φ) as well as by the toroidal vector (0,0,Tφ).Comparisons & characterizations of wave modalities, distribution of energy fields, velocities, diffusion rates, shear stress, boundary condition responses to the mantle surface materials, dielectrics and conductivity contribute to the operating conditions of the invention and influence the efficiency of the overall system dynamics.

There is also a passageway between the first rigid boundary liquid core mantle and a second spherical chamber that surrounds the first. Between the two chambers the recovered vapor and treated water are discharged here before passing into the filtrate holding tank prior to further treatment. The third or last outer boundary is not necessarily composed of ceramic material and can be plastic or fabricated steel. The purpose of the third boundary layer is to shield and hold the system. Herein, are inserted between the second and third chambers are the electrical apparatus and monitoring transducers that maintain & regulate pressure, temperature & other physical operating parameters. These rigid mantle structures are specifically designed to distribute the magnetic fields symmetrically outward from the core to distribute the energy in a directed & controllable manner.

The spherical geometry of the system, by its very nature exhibits certain problems relating to the thermal instability of fluid spheres and spherical shells with internal heat sources. So, it is necessary to map out the complexity of the variables into discrete functions. It is also necessary to view the data from the higher-level process dynamic where sludge is input into the system. The sludge is heated within the semi-spherical vessel and compared to sludge that is heated within the spherical vessel apparatus. A determination is made as to the content of the pathogens within the sludge prior to treatment and is measured after treatment and ratios of process temperatures, maximum & minimum-operating conditions is measured against the ratio of pathogens destroyed is determined. The quality of clean water produced is measured. The third most important measure is the potential to generate electricity within the production of an actual verified MHD generator. The proof of concept verification will be developed from the higher level analyses while the mathematical formulation of the necessary equations of the state of the research will define the discrete internal functions of the system kinematics.

Both vessels are secured within a square glass high frequency (RF) shielded supporting structure similar to the figure above. Analytical probes, pressure & temperature transducers, etc will be inserted within both vessel assemblies as well as the testing support chamber and are intended to define the operative metrics and determine the minimum & maximum levels of operation. The strategy is to define the metrics within the semi-spherical vessel as sequenced in the following objectives & experimental procedures. The second experiment includes all of the above details and the vessel geometry is change. A sphere is used to determine if there is a correlation between the cubic geometry of the core & the spherical rigid outer boundary vessel that differs significantly in its ability to destroy uniformly the pathogen content of the sludge, create a hybrid MHD generator producing an electric power. The use of the spherical lab scaled reactor vessel is the same in all-experimental aspects except that of geometry in the outer vessel. The change in symmetry is significant as most industrial MHD processes utilize the cylindrical shapes. Thus, It is intended to:

1. This invention that embodies a method for treating wastewater, sewage & sludge, known herein as the wastewater, sewage, raw slurry and sludge fluid is claimed.

2. An apparatus comprising a Hybrid MHD field sanitation (FSU) generator for raw slurry & sludge fluid treatment and recovery of potable water is claimed.

3. An apparatus, further comprising, a Hybrid MHD-FSU generator that uses the wastewater, sewage, raw slurry and sludge as the conductive medium is claimed.

4. An apparatus includes a method to recover a clean, pathogen free, potable water within the Hybrid MHD-FSU comprised of the following main components: mixer, hybrid-MHD sludge reactor chamber, filtration system, turbine, storage & holding tanks, DC battery storage system with power conditioning subsystem (PCS) and/or AC or alternative power source is claimed.

5. An apparatus comprised of an Hybrid MHD-FSU spherical or semi-spherical geometry reactor chamber is claimed.

6. The apparatus further embodies a core internally & centrally located within the 1^{st} of three spherical or semi-spherical, concentric geometries surrounding one another and comprising chambers is claimed such that each outer chamber is placed outside the initial reaction chamber and in succession from one another and that each of the three spherical or semi-spherical chambers fit neatly within one another.

7. The first spherical reactor chamber provides a sealed environment for wastewater, sewage, raw slurry or sludge treatment and represents a “liquid outer core region surrounding the cubic-core-magnetron assembly is claimed.

8. This invention presents the cubic core magnetron embodied within the centrally located cubic core of this invention as composing an inserted magnetron or other microwave, radio frequency, or high frequency generating device encased within a cubic perovskite ceramic.

9. It is further claimed that this cubic perovskite encasement is a waveguide assembly apparatus for the magnetron or other microwave, radio frequency or high frequency generating device and is used to focus & or direct the electromagnetic energy in a similar means as the typical rectilinear, or other such typical microwave sheet metal waveguide; and, is also used to allow transmission of the electromagnetic energy from the microwave cavity or applicator for similar purposes.

10. It is further embodied within the invention that the inner cubic core ceramic comprises one “MHD-electrode” of a pair and that the first outer rigid mantle boundary mantle spherically surrounding the wastewater liquid core chamber comprises the second “MHD electrode” and that both comprise the electrode pair.

11. It is further embodies within the invention that the cubic core-magnetron assembly is differentially rotated by a north polar motor assembly connection; and, that the 1^{st} & 2 cd outer rigid mantle boundary chambers are connected independently to a south polar motor assembly; and, it is further claimed that the core rotates one direction and the outer chambers rotate counterclockwise (differently to one another).

12. It is further embodied within the invention that the perovskite ceramics are comprised of fabricated aggregates of proppants containing fabricated (1) semi-conductive materials, (2) magnetic materials and (3) piezoelectric materials.

13. It is further embodied within the invention a means to generate acoustic pressure waves and sustain the standing waves within the liquid core reactor chamber centrally located between the two electrodes comprised of the cubic perovskite ceramic-magnetron assembly and the 1^{st} outer core rigid mantle boundary.

14. It is further embodied within the invention that the dielectric properties of the ceramics are fabricated specifically to match a resonant frequency of the electromagnetic radiation load & spherical harmonics to the dielectric of the wastewater, sewage & sludge.

15. It is further embodied within the invention that due to the dielectric properties of the combined MHD reactor chamber system; the fabricated semi-conductive nature of the ceramics; the insertion of magnetic elements within the ceramics; the generation of acoustic standing waves; and the differential rotation of the inner cubic core-magnetron assembly to the 1^{st} outer rigid mantle boundary that the wastewater, with its thixotropic & pseudoplastic properties, comprise a conductive fluid.

16. It is further embodied within the invention that this inner cubic core-wastewater liquid core-1^{st} outer rigid mantle boundary are the means to produce a “coupling to a magnetic field” together within the apparatus.

17. It is claimed herein that the apparatus of the invention provides the means, methods and processes to generate electrical power using the wastewater, sewage, raw slurry and sludge.

18. It is claimed herein that the apparatus of the invention comprises a means to recover treated, pathogen free water as a recovered resource.

19. It is claimed herein that the apparatus of the invention comprises a means to recover electrical power and uses a battery storage system with a power conditioning subsystem.

20. It is claimed herein that the apparatus of the invention comprises a means to recover treated organic material from the wastewater, sewage, raw slurry, sludge for useful applications, fertilizer, filler or any other such application that finds value in using clean, treated organic material.
